(19) United States
(12) Patent Application Publication
(10) Pub. No.: US 2008/0131088 A1
(43) Pub. Date: Jun. 5, 2008

(54) Image capture method and audio-video recording method of multi-media electronic device

(75) Inventor: Chun-Hsin Huang, Changhua County (TW)

Correspondence Address: BIRCH STEWART KOLASCH & BIRCH, PO BOX 747, FALLS CHURCH, VA, 22040-0747, US

(73) Assignee: Mitac Technology Corp.

(21) Appl. No.: 11/606,082

(22) Filed: Nov. 30, 2006

(51) Int. Cl. H04N 5/00; H04N 5/76; H04N 5/225

(52) U.S. Cl. 386/117; 348/231.99; 348/207.2; 348/E05.024

(57) ABSTRACT

An image capture method and an audio-video recording method of a multi-media electronic device are provided. The image capture method includes receiving a sequential image data; storing the image data into a first memory according to an image storage instruction; performing a de-interlace process on the image data in the first memory; and storing the de-interlaced image data into a second memory, thereby improving the operation convenience of the multi-media electronic device and enhancing the additional functions thereof.

### BACKGROUND OF THE INVENTION

1. Field of Invention

The present invention relates to an image capture method and an audio-video recording method, and more particularly to an image capture method and an audio-video recording method of a multi-media electronic device.

2. Related Art

Under many circumstances, a user is often disturbed by some external factors when watching an audio-video program. For example, the user has to go out upon an invitation from a friend when watching a ball game, and thus cannot finish the rest of the game, or the user cannot watch a movie played at 8:30 PM on time due to some reasons. At this time, most people will record the aforementioned programs in advance and watch them later in free time. However, to achieve the above purpose, a digital video recorder or a computer system is needed, which is not suitable for most of the people. Moreover, when the user intends to capture some pictures of a wonderful program when watching, the aforementioned method should also be employed, which is quite inconvenient in operation.

Referring to ROC Patent Publication No. M286528, a digital video recording TV equipment is disclosed, which includes an image receiving unit for receiving a digital image from an external camera. Then, an audio-video processing unit is utilized to process the digital image and an audio signal received by a microphone, so as to output an audio-video signal to a storage unit. Furthermore, a central processing unit (CPU) receives and processes the audio-video signal and a television signal from the external, so as to display the image of the audio-video signal or the television signal on a display.

Although in the aforementioned patent, a monitor picture and a TV program picture can be switched and preserved on the same display, thus achieving the purpose of preservation and entertainment. However, the picture or content of a TV program cannot be captured or recorded, so it is still inconvenient in operation.

Therefore, it has become one of the issues to be solved by researchers that how to provide an image capture method and an audio-video recording method of a multi-media electronic device, so as to enable the user to store, capture and record a TV program that is being played without adopting any external storage devices.

### SUMMARY OF THE INVENTION

Accordingly, the present invention is directed to provide an image capture method and an audio-video recording method of a multi-media electronic device, wherein memories are built in the multi-media device, the image or audio-video data captured or recorded in real time is de-interlaced and then output, so as to improve the operation convenience of the multi-media electronic device.

Therefore, to achieve the aforementioned objective, the image capture method of the multi-media electronic device provided by the present invention comprises: first, receiving a sequential image data; storing the image data into a first memory (for example, a volatile memory) according to an image storage instruction; performing a de-interlace process (for example, single-field de-interlace, dynamic adaptive de-interlace or dynamic compensation de-interlace) on the image data in the first memory; and storing the de-interlaced image data into a second memory (for example, a non-volatile memory).

Further, to achieve the aforementioned objective, the audio-video recording method of a multi-media electronic device provided by the present invention comprises: first, receiving a sequential audio-video data; storing the audio-video data into a first memory (for example, a volatile memory) according to an audio-video recording instruction; performing a de-interlace process (for example, single-field de-interlace, dynamic adaptive de-interlace or dynamic compensation de-interlace) on the audio-video data in the first memory; and storing the de-interlaced audio-video data into a second memory.

By using the image capture method and audio-video recording method of a multi-media electronic device, the user can capture or record the images or audio-video contents played in the multi-media electronic device in real time without the help of any externally-connected storage devices of large capacity, thereby improving the operation convenience of the multi-media electronic device and enhancing the additional functions thereof.

The features and practice of the present invention are illustrated below in detail through preferred embodiments with reference to the drawings.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1 is a flow chart of the steps of the image capture method of a multi-media electronic device according to the first embodiment of the present invention;

FIG. 2 is a schematic view of accessing the image data according to the first embodiment of the present invention;

FIG. 3 is a flow chart of the steps of the audio-video recording method of a multi-media electronic device according to the second embodiment of the present invention; and

FIG. 4 is a schematic view of accessing the audio-video according to the second embodiment of the present invention.

### DETAILED DESCRIPTION OF THE INVENTION

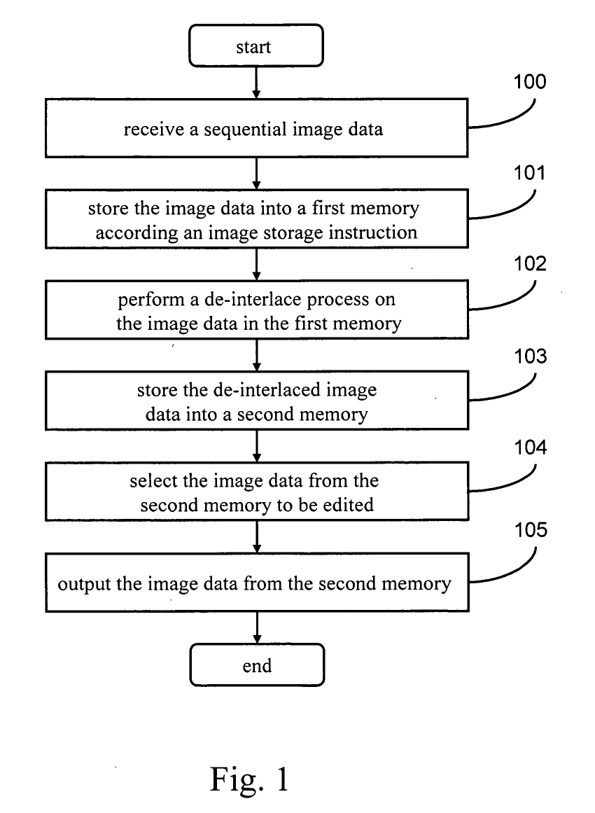

Referring to FIG. 1, it is a flow chart of the steps of the image capture method of a multi-media electronic device according to the first embodiment of the present invention. As shown in FIG. 1, the image capture method of a multi-media electronic device provided by the present invention includes the following steps. First, a sequential image data (for example, a TV image data) is received (Step 100). Then, the image data is stored into a first memory (Step 101) according to an image storage instruction, wherein the first memory is a volatile memory (for example, a dynamic random access memory (DRAM) or a static random access memory (SRAM)) and has a reading and writing speed faster than a second memory.

Next, the image data in the first memory is de-interlaced (Step 102). As the received image data is of an interlaced image data format, to align the image with a time axis in a progressive scan display unit, a de-interlace process is needed here to improve the picture quality. The de-interlace process, such as single-field de-interlace, dynamic adaptive de-interlace or dynamic compensation de-interlace, can be adopted.

Afterward, the de-interlaced image data is stored in the second memory (Step 103), wherein the second memory is a non-volatile memory, such as an erasable programmable read-only memory (EPROM), an electrically erasable programmable read only memory (EEPROM) or a flash memory.

Then, the image data is selected from the second memory to be edited (Step 104), wherein the image data can be named, edited and deleted by a user. Finally, the image data is output from the second memory (Step 105) to a peripheral device (for example, a printer), wherein the image data in the second memory is output to a printer through a wireless or wired transmission mode.

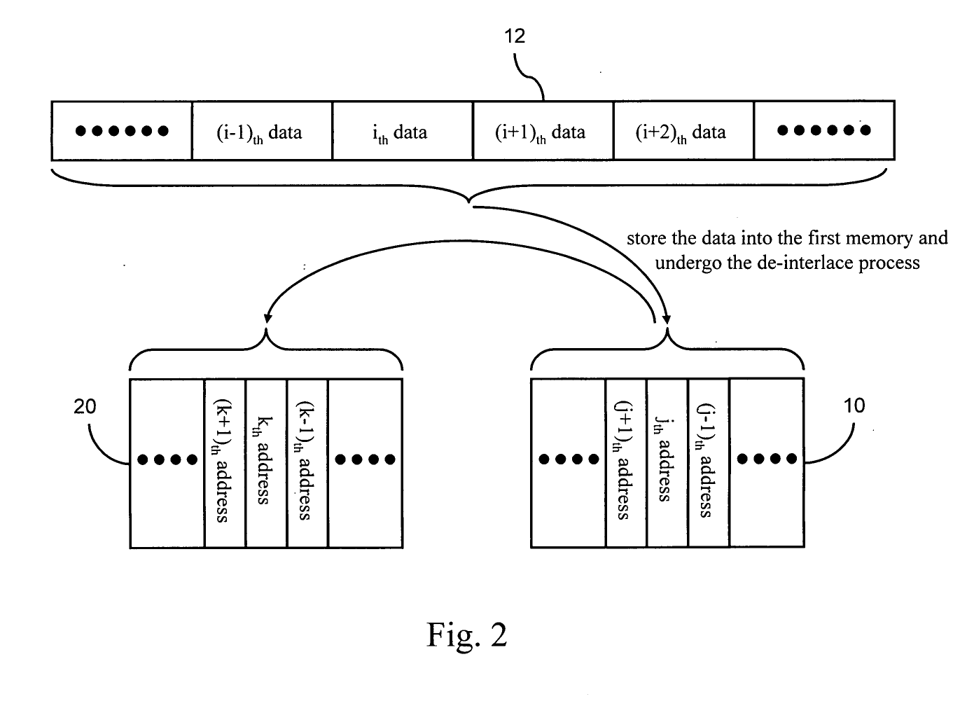

Referring to FIG. 2, it is a schematic view of accessing the image data according to the first embodiment of the present invention. Firstly, the multi-media electronic device receives an interlaced image data 12, i.e., the (i−1)ₜₕ data, iₜₕ data, (i+1)ₜₕ data, (i+2)ₜₕ data, and so on. When the user designates an image capture instruction (for example, pressing the image capture key on a remote control or a control panel) when the iₜₕ data is played, the interlaced image data 12 is temporarily stored in corresponding addresses in the first memory 10, i.e., the jₜₕ address, (j+1)ₜₕ address, and so on. Then, a de-interlace process (for example, single-field de-interlace, dynamic adaptive de-interlace or dynamic compensation de-interlace) is performed on the interlaced image data 12 in the jₜₕ address, (j+1)ₜₕ address, and so on. After that, the de-interlaced image data that is stored into corresponding addresses in the second memory 20, i.e., the kₜₕ address, (k+1)ₜₕ address, and so on. Finally, the image data in the second memory 20 is processed and then transmitted to a peripheral device (for example, a printer), wherein the image data can be output from the second memory 20 through a wireless or wired transmission mode.

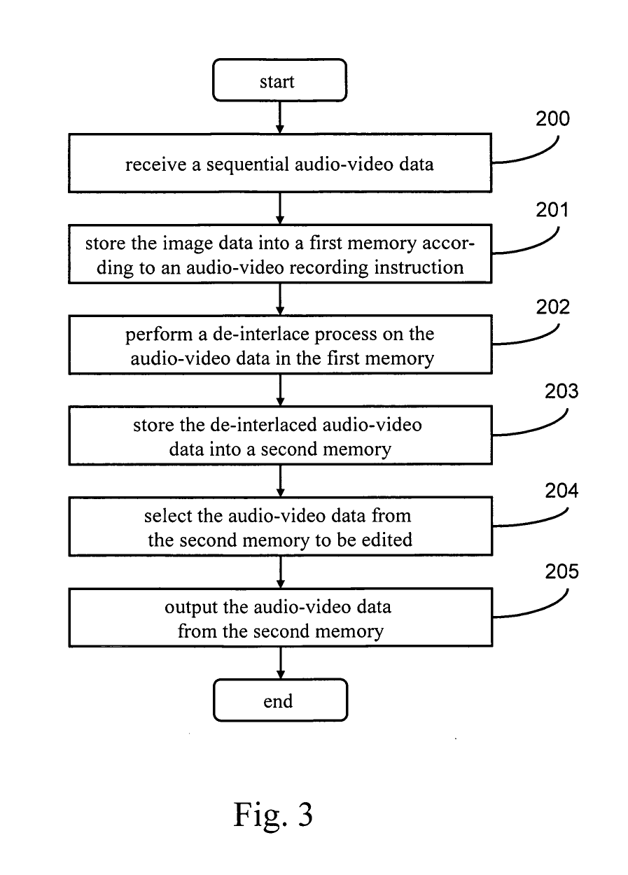

Referring to FIG. 3, it is a flow chart of the steps of the audio-video recording method of a multi-media electronic device according to the second embodiment of the present invention. As shown in FIG. 3, the audio-video recording method of a multi-media electronic device provided by the present invention includes the following steps. First, a sequential audio-video data (for example, a TV audio-video data) is received (Step 200). Then, the audio-video data is stored into a first memory according to an audio-video recording instruction (Step 201), wherein the first memory is a volatile memory (for example, a DRAM or an SRAM) and has a reading and writing speed faster than a second memory.

Next, a de-interlace process is performed on the audio-video data in the first memory (Step 202). As the image data in the received audio-video data is of an interlaced image data format, in order to align the image with a time axis in a progressive scan display unit, the de-interlace process is needed here to improve the picture quality. The de-interlace process, such as single-field de-interlace, dynamic adaptive de-interlace or dynamic compensation de-interlace, can be adopted.

Afterward, the de-interlaced audio-video data is stored in a second memory (Step 203), wherein the second memory is a non-volatile memory, such as an EPROM, an EEPROM or a flash memory.

The audio-video data is selected from the second memory to be edited (Step 104), wherein the audio-video data can be named, edited and deleted by a user. Finally, the audio-video data is output from the second memory (Step 105) to a peripheral device (for example, a screen and/or a loudspeaker), wherein the audio-video data in the second memory is output to the screen and/or loudspeaker through a wireless or wired transmission mode.

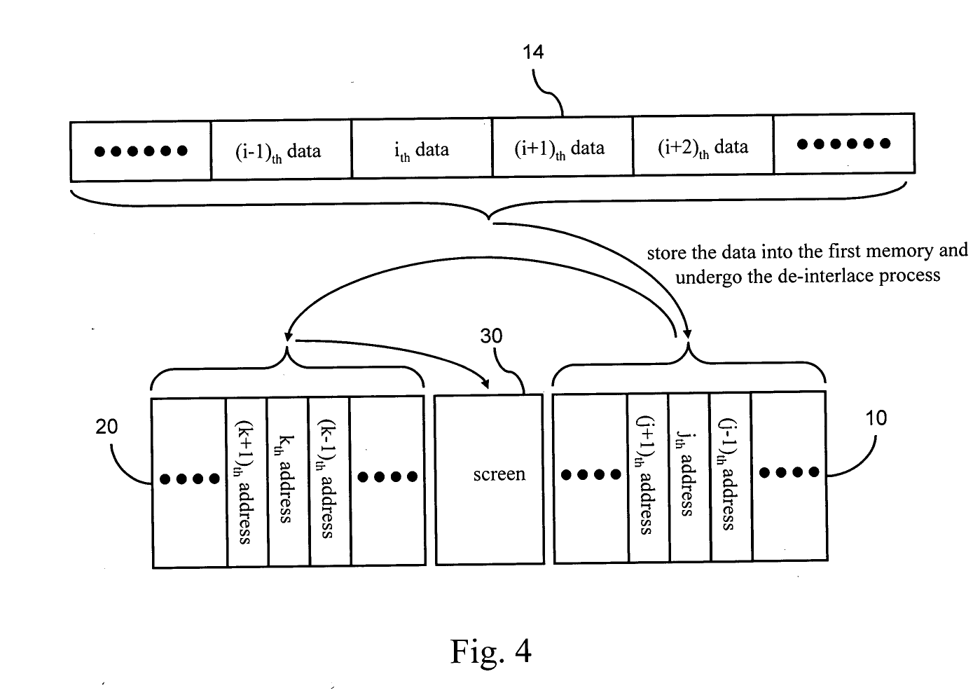

Referring to FIG. 4, it is a schematic view of accessing the audio-video data according to the second embodiment of the present invention. First, a multi-media electronic device receives a sequential audio-video data, wherein the image data in the received sequential audio-video data is an interlaced image data 14, i.e., the (i−1)ₜₕ data, iₜₕ data, (i+1)ₜₕ data, (i+2)ₜₕ data, and so on. When the user designates an audio-video recording instruction (for example, pressing an audio-video recording key on a remote control or a control panel) when the (i−1)ₜₕ data is played, the interlaced image data 14 is temporarily stored in corresponding addresses in the first memory 10, i.e., the (j−1)ₜₕ address, jₜₕ address, (j+1)ₜₕ address, and so on. Then, a de-interlace process (for example, single-field de-interlace, dynamic adaptive de-interlace or dynamic compensation de-interlace) is performed on the interlaced image data 14 in the (j−1)ₜₕ address, jₜₕ address, (j+1)ₜₕ address, and so on. After that, the de-interlaced image data is stored into corresponding addresses in the second memory 20, i.e., the (k−1)ₜₕ address, kₜₕ address, (k+1)ₜₕ address, and so on. Finally, the audio-video data in the second memory 20 is processed and then transmitted to a screen 30 (a single picture or a picture-in-picture) to be output, wherein the image data in the second memory 20 can be output to the screen 30 through a wireless or wired transmission mode.

Additionally, when recording the interlaced image data 14, the user can return to enjoy the previous audio-video content at any time, and meanwhile the multi-media electronic device continues recording the current audio-video data. For example, the user begins recording from the (i−1)ₜₕ data and enjoy the corresponding audio-video content at the same time. When the program proceeds to the (i+35)ₜₕ data, the user can still return to enjoy the audio-video content of the (i−1)ₜₕ data via a control menu, and meanwhile the multi-media electronic device continues recording the audio-video content following the (i+35)ₜₕ data, such as the (i+36)ₜₕ data, (i+37)ₜₕ data. As such, the operation convenience of the multi-media electronic device is greatly enhanced.

By using the image capture method and the audio-video recording method of the multi-media electronic device, the memories are built in the multi-media electronic device to store the image data or audio-video data to be captured or recorded. As such, the user may capture or record the image or audio-video content played in the multi-media electronic device in real time without the help of any externally-connected storage devices of large capacity, thereby improving the operation convenience of the multi-media electronic device and enhancing the additional functions thereof.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An image capture method of a multi-media electronic device, comprising:
receiving a sequential image data;
storing the image data into a first memory according to an image storage instruction;
performing a de-interlace process on the image data in the first memory; and
storing the de-interlaced image data into a second memory.

2. The image capture method of a multi-media electronic device as claimed in claim 1, after the step of storing the de-interlaced image data into a second memory, further comprising:
selecting the image data from the second memory to be edited; and
outputting the image data from the second memory.

3. The image capture method of a multi-media electronic device as claimed in claim 2, wherein the image data in the second memory is output to a printer through a wireless transmission mode.

4. The image capture method of a multi-media electronic device as claimed in claim 2, wherein the image data in the second memory is output to a printer through a wired transmission mode.

5. The image capture method of a multi-media electronic device as claimed in claim 1, wherein the first memory is a volatile memory.

6. The image capture method of a multi-media electronic device as claimed in claim 1, wherein the second memory is a non-volatile memory.

7. The image capture method of a multi-media electronic device as claimed in claim 1, wherein the de-interlace process is single-field de-interlace, dynamic adaptive de-interlace or dynamic compensation de-interlace.

8. An audio-video recording method of a multi-media electronic device, comprising:
receiving a sequential audio-video data;
storing the audio-video data into a first memory according to an audio-video recording instruction;
performing a de-interlace process on the audio-video data in the first memory; and
storing the de-interlaced audio-video data into a second memory.

9. The audio-video recording method of a multi-media electronic device as claimed in claim 8, after the step of storing the de-interlaced audio-video data into a second memory, further comprising:
selecting the audio-video data from the second memory to be edited; and
outputting the audio-video data from the second memory

10. The audio-video recording method of a multi-media electronic device as claimed in claim 9, wherein the audio-video data in the second memory is output to a single picture.

11. The audio-video recording method of a multi-media electronic device as claimed in claim 9, wherein the audio-video data in the second memory is output to a picture-in-picture.

12. The audio-video recording method of a multi-media electronic device as claimed in claim 8, wherein the first memory is a volatile memory.

13. The audio-video recording method of a multi-media electronic device as claimed in claim 8, wherein the second memory is a non-volatile memory.

14. The audio-video recording method of a multi-media electronic device as claimed in claim 8, wherein the de-interlace process is single-field de-interlace, dynamic adaptive de-interlace or dynamic compensation de-interlace.
